(19) United States
(12) Patent Application Publication
(10) Pub. No.: US 2005/0083593 A1
(43) Pub. Date: Apr. 21, 2005

(54) Prism curtains

(76) Inventor: Nancy Alisa Gibbons Addison, Dallas, TX (US)

Correspondence Address: LOCKE LIDDELL & SAPP LLP;ATTN: SUE COTT, 2200 ROSS AVENUE, SUITE 2200, DALLAS, TX, 75201-6776, US

(21) Appl. No.: 10/455,732

(22) Filed: Oct. 15, 2003

(51) Int. Cl. G02B 5/04

(52) U.S. Cl. 359/837; 359/615

(57) ABSTRACT

A decorative window treatment for residential or commercial applications, and may optionally be configured for use at locations other than a window. The decorative light diffusing window treatment comprises a number of interconnected prism elements that produce a visually appealing color spectrum when white light is applied and passes therethrough. In use, the decorative window treatment provides a visual obstacle from the outside, while allowing light penetration through to the inside.

### BACKGROUND OF THE INVENTION

1. Field of the Invention

This invention relates generally to decorative window treatments. More particularly, the invention relates to a novel light-diffusing window treatment that produces a color spectrum.

2. Description of Related Art

The use of ornamental and colored glass in windows to create aesthetically pleasing light presentations is well known in the prior art. Commonly, stained glass windows utilize geometrically arranged colored glass sections to create desired visual effects. Examples of such ornamental stained glass window treatments are illustrated in U.S. Pat. Nos. 4,223,499 and 4,610,901. Other known ornamental window treatments provide colored patterns through which incoming white light passes, thereby illuminating the patterns thereon. An example of such an ornamental window treatment is illustrated in U.S. Pat No. 4,078,492. The known prior art window treatments do not fully produce light spectrum displays of visual appeal. Further, the known prior art window treatments rely primarily on the pattern selected by the artist, rather than on the naturally and randomly occurring spectrum displays produced by a geometric prism. Still further, the known prior art window treatments do not embody multiple interconnected prism structures to produce aesthetically pleasing light spectrum displays. Other disadvantages of the known prior art window treatments, as well as advantages of the present inventive prism curtain, will be evident to those of skill in the art. As will be appreciated, the present invention comprises a novel and advantageous combination of elements not disclosed in the decorative window treatments of the prior art.

### BRIEF SUMMARY OF THE INVENTION

In view of the disadvantages of the known prior art window treatments, the present invention provides a prism curtain utilizing the light diffusing characteristics of the prism to produce aesthetically pleasing visual displays.

It is a general object of the present invention to provide an ornamental window treatment comprising a number of interconnected prismatic elements, whereby an area of incoming or emitted light (such as light through a window) may be utilized to produce aesthetically pleasing light spectrums.

Another more general object of the present invention is to provide for the production of random and natural rainbow effects in an interior environment.

Yet another general object of the present invention is to provide an ornamental window treatment that allows for a measure of interior visual privacy relative to an exterior space.

Still another object of the present invention is to provide visual relief to persons in an interior space relative to an aesthetically undesirable exterior space.

The prismatic curtain of the present invention generally comprises a number of interconnected prismatic structures. The interconnected arrangement may be proportioned such that a given window boundary is taken up, thus producing an aesthetically pleasing window treatment having properties which are the object of the present invention.

The foregoing has outlined some of the more pertinent disadvantages of the known prior art, as well as some of the more pertinent advantages and objects of the present invention. These objects should be construed as merely illustrative of some of the more prominent features and applications of the invention. Many other beneficial results can be attained by utilizing and configuring the invention as will be described herein. Accordingly, other objects and a further understanding of the present invention may be had by referring to the following Detailed Description of the Preferred Embodiment.

### BRIEF DESCRIPTION OF THE DRAWINGS

Various preferred embodiments of the current invention are further described and explained in relation to the following figures wherein:

FIG. 1 is an ordinary window without any window treatment applied thereon;

FIG. 2 is a front view of an embodiment of the present invention;

FIG. 3 is a front view of an embodiment of a prism element of the present invention;

FIG. 4 is a side view of an embodiment of a prism element of the present invention;

FIG. 5 is a cross-sectional view of an embodiment of the present invention; and

FIG. 6 is a cross-sectional view of an embodiment of the present invention.

### DETAILED DESCRIPTION OF THE PREFERRED EMBODIMENT

The preferred and alternative embodiments of the present invention are described and illustrated herein with respect to their primary use in an ordinary residential window space. It is understood, however, that the present invention is not limited to use with such windows, and may be adapted for use with other types and shapes of windows as well. It is further understood that the present invention may be adapted for use in spaces other than windows, wherever the aesthetic properties of the present invention are desired. Such spaces may include, for example, awnings, lamp shades, standing wall privacy screens, and umbrellas. Those of skill in the art will recognize a multitude of uses for the present invention, and those enumerated specifically herein are illustrative only, and do not limit the scope of the present invention. Thus, it is expressed that the term “window,” as used with respect to the description of the present invention, is merely descriptive of a preferred embodiment of the invention, and the invention may be utilized in locations other than windows.

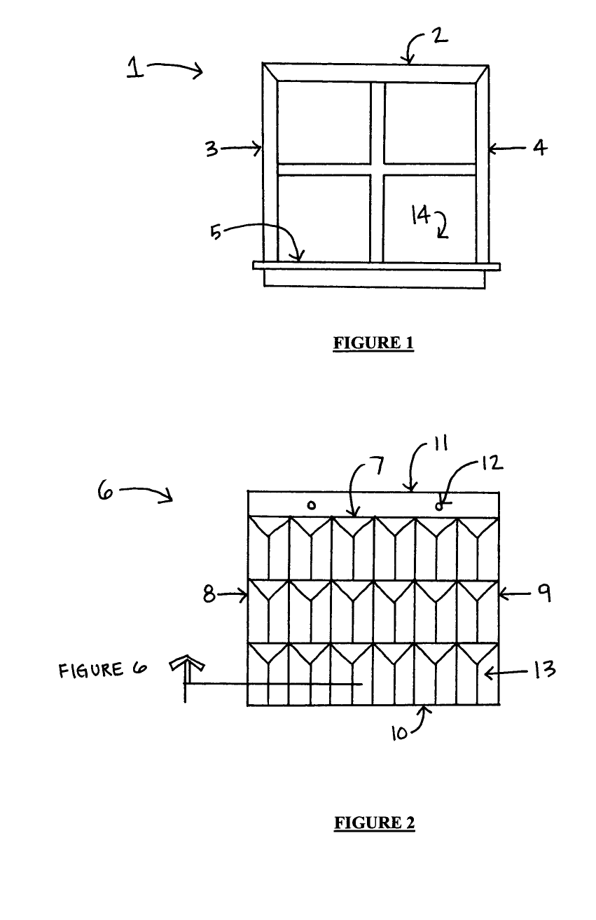

Referring now to FIG. 1, an ordinary residential window 1 is illustrated. The window 1 is generally square, having a top side 2, a left side 3, a right side 4, and a bottom side 5. The window 1 is generally clear, thereby allowing natural sunlight to pass therethrough.

Referring now to FIG. 2, an embodiment of the present prism curtain invention is illustrated, and is identified by the numeral identifier 6. The prism curtain 6 comprises a top end 7, a first edge 8, a second edge 9, and a bottom edge 10. Along a portion of top end 7 is mounting member 11. Mounting member 11 has a pair of grommets 12 useful for mounting prism curtain 6 along the top side 2 of window 1. It will be understood that mounting member 11 may be of any desired configuration and needs not be located necessarily along top end 7. Any desired mounting location may be employed without detracting from the present invention. For example, a pair of mounting members 11 may be utilized by providing one along first edge 8 and one along second edge 9. Moreover, it will be understood that grommets 12 are merely illustrative of a type of mounting means for prism curtain 6. Any desired mounting mechanism may be employed without detracting from the present invention, including brackets, nails, tacks, clips, hooks, adhesives, hook and loop fasteners, and the like.

Alternatively, the mounting member may be eliminated entirely. In the absence of mounting member 11, the prism curtain 6 may be dimensioned such that it fits squarely and securely within the space defined by window 1. Alternatively, prism curtain 6 may be simply leaned against a support object such as a glass pane 14 of window 1 or any other desired object or surface. Alternatively, prism curtain 6 may comprise integrally-molded apertures or mounting structures useful for mounting the curtain.

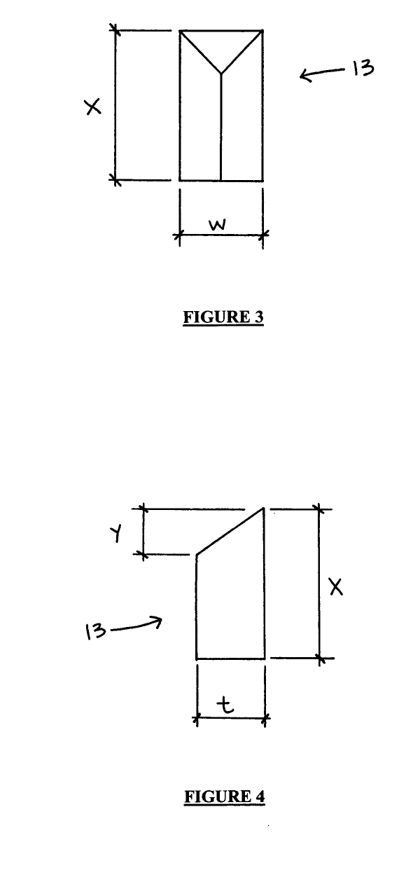

Prism curtain 6 comprises a number of individual prism elements 13. As shown more specifically in FIGS. 3, 4 and 5, prism element 13 is generally triangular in cross section and is manufactured of a transparent or semi-transparent material such as glass or plastic. Preferably, prism element 13 is manufactured of a low viscosity casting urethane resin. Prism element 13 may be clear, or may be tinted with any desired color. Preferably, prism element 13 is about one and one-quarter inch (1¼″) in thickness “t”, about one and one-quarter inch (1¼″) in width “w”, about two and one-quarter inches (2¼″) in length “x”, and has a front slope distance “y” of about one-half inch (½″). It is understood that prism element 13 may be of any desired dimension, and the dimensions enumerated herein are merely descriptive of a preferred embodiment of the present invention. Moreover, it is understood that the shape of prism element 13 is not limited to the triangular cross section illustrated in FIGS. 3, 4, and 5. Those of skill in the art will appreciate that prism element 13 may be of a teardrop, pyramid, oval, square, rectangle, or other shape without detracting from the present invention. The characteristic embodied in the shape chosen for prism element 13 is that of separating white light into its constituent colors, i.e., producing a spectrum of colors. Any shape selected for prism element 13 that produces the desired color spectrum, or a substantial part thereof, is acceptable and may be employed in the present invention.

Referring now again to FIG. 2, prism curtain 6 comprises a number of individual prism elements 13 in one embodiment of the present invention. Prism elements 13 are interconnected by adhesive means such as glue or epoxy. Alternatively, individual prism elements 13 may be loosely or securely interconnected by securing means such as clips, ties, string, or the like. Those of ordinary skill will appreciate a number of mechanisms useful for interconnecting individual prism elements 13. The interconnected prism elements 13, in combination, form a single prism curtain 6. Single or multiple prism curtains 6 may be utilized together in a space as desired or as necessary to effect the desired aesthetic result.

Referring now again to FIG. 2 and also FIG. 6, an alternative embodiment of the present inventive prism curtain is illustrated. In this alternative and preferred embodiment, prism curtain 6 comprises a single uniformly-molded prism configuration. In this embodiment, prism curtain 6 is produced out of a hard plastic silicone mold. Thus, individual prism elements 13 are integrally molded, as illustrated best in FIG. 6. In this embodiment, individual prism elements 13 are closely-spaced such that visual perception through prism curtain 6 is minimized when in use. Preferably, the thickness “b” of base layer 15 is about one-quarter inch (¼″). Optionally, edge extension “k” is provided along first edge 8. Edge extension “k” may be of any desired dimension, preferably about one inch (1″). It is understood that edge extension “k” may be provided at any, all, some, or none of the edges of prism curtain 6.

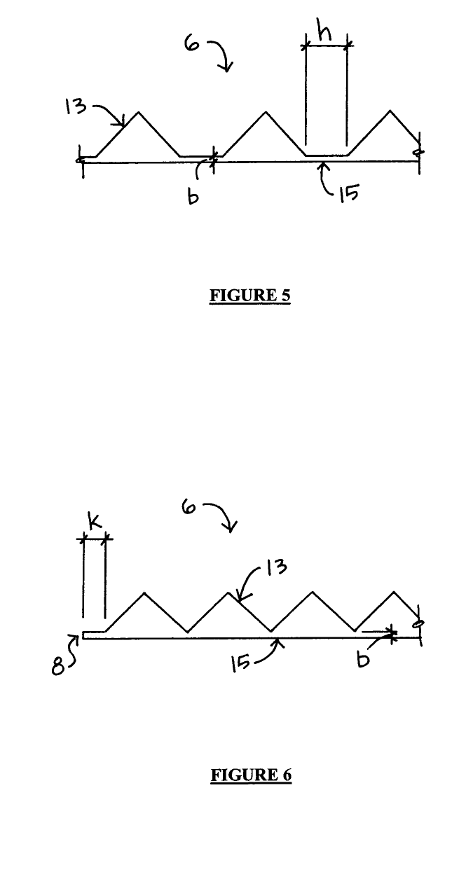

Referring now again to FIG. 5, an alternative embodiment of the present inventive prism curtain is illustrated. In this alternative embodiment, prism curtain 6 comprises a single uniformly-molded prism configuration. In this embodiment, prism elements 13 are integrally molded, and individual prism elements 13 are widely-spaced such that visual perception through prism curtain 6 is relatively unobstructed by prism elements 13. Preferably, the thickness “b” of base layer 15 is about one-quarter inch (¼″), and prism spacing “h” is about one inch (1″). Of course, any prism spacing “h” may be utilized, depending on the desired clarity of visual perception through prism curtain 6. For greater visual clarity, a larger prism spacing “h” may be used.

Having thus described the present invention in terms of several alternative and preferred embodiments, it is recognized that those of skill in the art will appreciate the several advantages inherent in the present invention over the prior art. It is further recognized that those of skill in the art will appreciate the numerous geometric configurations which may be employed in designing the individual prism elements 13 without detracting from the present invention. Such geometric configurations include those shapes and sections which act a prisms for applied white light, thereby separating the white light into its constituent colors, i.e., produce a spectrum of colors. It will be further appreciated by those of skill in the art that the structures and properties of the present invention may be utilized in a number of environments other than residential window openings, including, for example, doorways, interior lighting fixtures, partitions, and the like.

1. A decorative window treatment comprising:
a number of interconnected prism elements;
said prism elements being configured such that applied white light is dispersed into a spectrum of color.

2. A decorative window treatment as described in claim 1, wherein:
said prism elements are integrally molded.

3. A decorative window treatment as described in claim 1, wherein:
said prism elements are interconnected by adhesive means.

4. A decorative window treatment as described in claim 1, wherein:
said prism elements are interconnected by securing means.

5. A decorative window treatment as described in claim 1, further comprising means for mounting.

6. A decorative window treatment as described in claim 2, wherein:
said integrally molded prism elements are closely-spaced such that visual perception through and between said number of prism elements is reduced.

7. A decorative window treatment as described in claim 2, wherein:
said integrally molded prism elements are widely-spaced such that visual perception through and between said number of prism elements is increased.
